(19) United States
(12) Patent Application Publication
(10) Pub. No.: US 2013/0337734 A1
(43) Pub. Date: Dec. 19, 2013

(54) CONTROLLABLE AIR INLET FOR A MOTOR VEHICLE

(71) Applicant: Decoma (Germany) GmbH, Sulzbach (DE)

(72) Inventor: Bernd KNAUER, Esslingen (DE)

(73) Assignee: Decoma (Germany) GmbH, Sulzbach (DE)

(21) Appl. No.: 13/916,691

(22) Filed: Jun. 13, 2013

(30) Foreign Application Priority Data
Jun. 13, 2012 (DE) DE 102012011594.6

(51) Int. Cl. B60H 1/00

(52) U.S. Cl. CPC B60H 1/00457
USPC 454/152

(57) ABSTRACT

A controllable air inlet for a motor vehicle for controlling the air to be supplied to a heat exchanger or other cooling device of an internal combustion engine. The air inlet includes a closing element pivotable about an axis and a surface facing in the direction of the airflow to be controlled.

### CROSS-REFERENCE TO RELATED APPLICATIONS

The present application claims priority under 35 U.S.C. §119 to German Patent Application No. DE 10 2012 011 594.6 (filed on (Jun. 13, 2012), which is hereby incorporated by reference in its entirety.

### TECHNICAL FIELD

A controllable air inlet configured to control the air to be supplied to a heat exchanger or other cooling device of an internal combustion engine of a motor vehicle.

### BACKGROUND

In conventional motor vehicles, airflow to the heat exchanger is controlled by way of adjustable elements in order to enhance the warm-up behaviour of the engine. The adjustable elements, the closing elements, are generally a number of pivotably mounted flaps, in which the pivot axes thereof are oriented parallel to one another and the flaps as a whole are arranged rotatably in a frame. The frame, together with the flap arrangement, is arranged downstream of the radiator grille and upstream of the heat exchanger of the engine. Such an arrangement may also be arranged in a flow channel, via which cool air is supplied to the radiator of the engine from an opening to the heat exchanger arranged in the vehicle body. By closing the fresh air supply during the warm-up phase and/or by controlling the quantity of cool air in accordance with the engine temperature, the optimal operating temperature is more rapidly reached and/or may be kept within a narrow temperature range.

Examples of the described devices are disclosed in EP 2 233 341 A1, EP 2 233 342 A1, EP 2 325 035 A1, DE 10 2008 049 010 A1, DE 20 2005 010 683 U1 as well as DE 60 2004 007 338 T2.

The disclosed closing elements are configured as elongate planar elements of substantially flat shape and are pivotable about an axis running generally centrally through the planar element. In the closed state, elements designed in such a manner are disadvantageously subjected to load by the air pressure acting thereon. In the open state, the closing elements are located in the airflow, so that the cross section for the passage of air is reduced. A flap with a streamlined cross section is disclosed in EP 2 335 963 A1. The effects of flow technology on the closing element are thus slightly minimized but are not essentially avoided.

In DE 10 2009 009 141 A1, amongst other things, pivotably mounted closing elements are provided, the closing elements in each case being arranged in an air passage gap. The pivotable closing elements clearly pivot in the same direction for opening the respective gaps or closing the respective gaps.

DE 20 2004 010 030 U1 discloses compression flaps of planar configuration in a fan shroud. Predetermined fracture lines permit the manufacture of such a fan shroud which is optimized in terms of tooling.

DE 10 2004 026 419 A1 discloses a device for adapting the passage of air in the front region of a motor vehicle, consisting of an upper air capture zone and a lower air capture zone having in each case flaps.

### SUMMARY

Embodiments are directed to a controllable air inlet having an enhanced design relative to conventional designs.

In accordance with embodiments, a controllable air inlet configured to control the air to be supplied to a heat exchanger or other cooling device of an internal combustion engine of a motor vehicle, and includes at least one of: a pair of closing elements pivotable in opposing directions about one respective axis, in which the pivot axes extend parallel to one another, the pair of closing elements being arranged in a frame which bears the closing elements and as a whole defines the maximum throughput for the airflow, one closing element is assigned to the upper frame element, the second closing element is assigned to the lower frame element, and each closing element has a surface facing in the direction of the airflow to be controlled, which is designed substantially cylindrically to the pivot axis assigned to the closing element. In the closed state, the cylindrical outer faces of the cylindrical flaps face in the direction of the airflow to be controlled and completely close the open surface of the frame. In the open state, the cylindrical outer surface portions of the closing elements are pivoted upwards and/or downwards, so that the cross section of the frame is opened up.

In accordance with embodiments, the closing element is configured as a portion of a cylindrical outer surface, as a cylindrical flap. The cylindrical outer surface portion is defined on both sides by one respective plate having the axis, in particular in the form of a bearing pin, bearing the closing element.

Embodiments are related to an air inlet configured to control airflow to a cooling device of an internal combustion engine for a motor vehicle, and includes at least one of: first and second closing elements pivotably movable in opposing directions about a respective axis, wherein the pivot axes extend parallel to one another and each closing element has a surface facing in a direction of the airflow to be controlled and which is substantially cylindrically to the pivot axis assigned to the closing element; and a frame which receives the closing elements in a manner which defines a maximum throughput for the airflow, wherein the first closing element is assigned to an upper frame element and the second closing elements is assigned to a lower frame element.

Embodiments are related to an air inlet configured to control airflow to a cooling device of an internal combustion engine for a motor vehicle, and includes at least one of: a first closing element pivotably movable along a first pivot axis between an open position to permit airflow through the air inlet and a closed position which restricts airflows through the air inlet; a second closing elements pivotably movable along a second pivot axis in an opposing direction relative to the first closing element; and a frame having a first frame element operatively connected to the first closing element and a second frame element operatively connected to the second closing element.

Embodiments are related to an air inlet configured to control airflow to a cooling device of an internal combustion engine for a motor vehicle, and includes at least one of: a first closing element pivotably movable along a first pivot axis between an open position to permit airflow through the air inlet and a closed position which restricts airflows through the air inlet; a first frame element operatively connected to the first closing element and about which the first closing element pivots; a second closing elements pivotably movable along a second pivot axis in an opposing direction relative to the first closing element; and a second frame element operatively connected to the second closing element and about which the first closing element pivots.

Embodiments are related to an air inlet configured to control airflow to a cooling device of an internal combustion engine for a motor vehicle, and includes at least one of: a first closing element pivotably movable along a first pivot axis between an open position to permit airflow through the air inlet and a closed position which restricts airflows through the air inlet, the first closing element having a first surface facing in a direction facing the airflow to be controlled when the first closing element is in the closed position; a first frame element operatively connected to the first closing element and about which the first closing element pivots; a second closing elements pivotably movable along a second pivot axis in an opposing direction relative to the first closing element, the second closing element having a second surface facing in a direction of the airflow to be controlled when the second closing element is in the closed position; and a second frame element operatively connected to the second closing element and about which the first closing element pivots.

By way of the described shape of the closing elements, the closing elements have a high degree of rigidity relative to the airflow to be controlled. Additionally, one or more reinforcing ribs may be integrally formed on the inner face of the cylindrical outer surface portion.

### DRAWINGS

Embodiments are described by way of example below with reference to the drawings.

FIG. 1 illustrates a perspective view of a controllable air inlet in a closed state with a frame with an upper frame part and a lower frame part, in an in accordance with embodiments.

FIG. 2 illustrates an open state of the controllable air inlet, in accordance with embodiments.

FIGS. 3 and 4 illustrate a controllable air inlet, in accordance with embodiments.

### DESCRIPTION

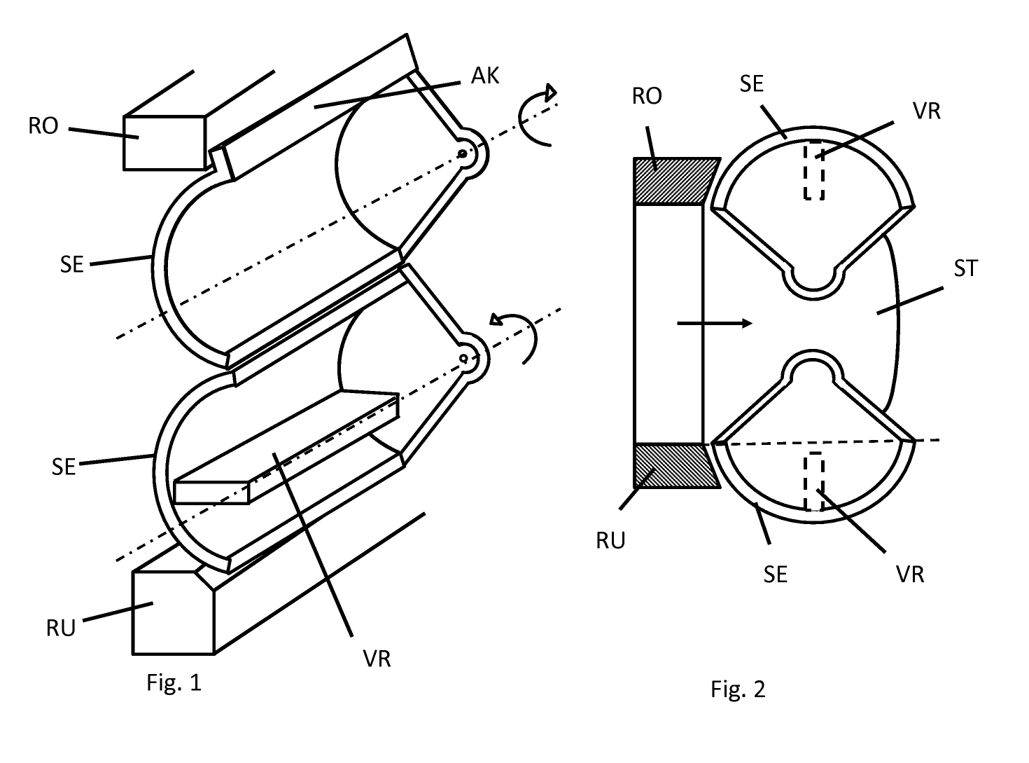

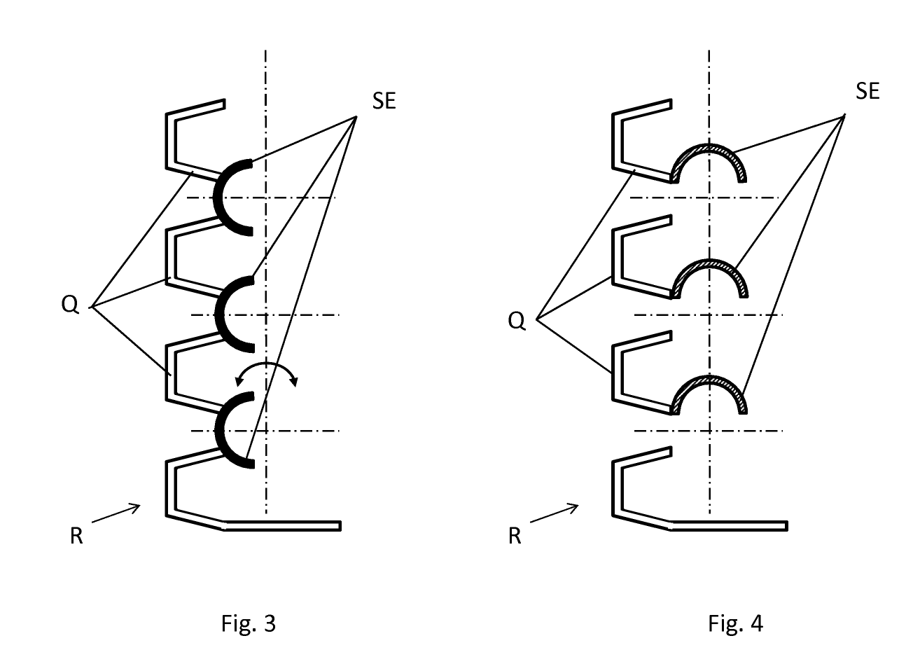

FIGS. 1 to 4 illustrate a controllable air inlet configured to control the air to be supplied to a heat exchanger or other cooling device of an internal combustion engine of a motor vehicle.

FIG. 1 illustrates in a perspective view a section through a frame with an upper frame part and a lower frame part RO, RU. The pins of one respective closing element SE formed as a cylindrical outer surface portion are mounted in two opposing side parts ST of the frame.

In FIG. 1, the closed state of the air inlet is illustrated, in which the concave outer faces of the closing elements SE formed as cylindrical outer surface portions prevent the entry of air. A stop contour AK cooperating with the respective frame part RO RU is integrally formed on the upper closing element and the lower closing element SE, on each terminal edge of the outer surface, the stop contour limiting the pivoting movement of the closing element SE in the closing direction. The stop contour AK is only shown on the upper closing element. The opposing pivoting directions of the two closing elements SE about the pivot axes thereof are represented in FIG. 1 by the arrows.

FIG. 2 illustrates the open state of the air inlet. The closing elements SE are pivoted upwards and downwards and thus fully open up the surface of the frame through which air is able to flow, defined by the frame parts RO, RU and the side parts ST. The direction of the air inflow is represented in FIG. 2 by the arrow.

One respective reinforcing rib VR extending over the length of the closing element SE is integrally formed on the closing elements SE on the concave inner face, indicated in dashed lines in FIGS. 1 and 2. The reinforcing rib increases the rigidity of the closing element, in particular in the position in which the passage of air is completely closed.

The closing elements SE formed as cylindrical outer surface portions are configured to be adjusted together as a group simultaneously via an actuator (not illustrated). Accordingly, the closing elements SE are coupled together in terms of gear technology, for example, via toothed segments or a coupling rod. It may also be provided that individual closing elements SE may be separately adjusted by one respectively assigned actuator.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### LIST OF REFERENCE SIGNS

R Frame
RO Frame upper part, upper strut
RU Frame lower part, lower strut
ST Frame side part
SE Closing element, cylindrical outer surface portion, rolling flap
VR Reinforcing rib

What is claimed is:

1. An air inlet configured to control airflow to a cooling device of an internal combustion engine for a motor vehicle, comprising:
first and second closing elements pivotably movable in opposing directions about a respective axis, wherein the pivot axes extend parallel to one another and each closing element has a surface facing in a direction of the airflow to be controlled and which is substantially cylindrically to the pivot axis assigned to the closing element; and
a frame which receives the closing elements in a manner which defines a maximum throughput for the airflow, wherein the first closing element is assigned to an upper frame element and the second closing elements is assigned to a lower frame element.

2. The air inlet of claim 1, wherein the closing elements comprise a cylindrical outer surface.

3. The air inlet of claim 2, wherein the closing elements comprise a concave surface on a side remote from the airflow to be controlled.

4. The air inlet of claim 3, wherein the closing element comprises a reinforcing rib aligned with the pivot axis.

5. The air inlet of claim 1, wherein the closing elements comprise a concave surface on a side remote from the airflow to be controlled.

6. The air inlet of claim 6, wherein the closing element comprises a reinforcing rib at the concave surface and which is aligned with the pivot axis.

7. The air inlet of claim 1, wherein the closing element comprises a reinforcing rib aligned with the pivot axis.

8. An air inlet configured to control airflow to a cooling device of an internal combustion engine for a motor vehicle, comprising:
a first closing element pivotably movable along a first pivot axis between an open position to permit airflow through the air inlet and a closed position which restricts airflows through the air inlet;
a second closing elements pivotably movable along a second pivot axis in an opposing direction relative to the first closing element; and
a frame having a first frame element operatively connected to the first closing element and a second frame element operatively connected to the second closing element.

9. The air inlet of claim 8, wherein the first pivot axis and the second pivot axis extend parallel to one another.

10. The air inlet of claim 8, wherein:
the first closing element has a first surface facing in a direction of the airflow to be controlled when the first closing element is in the closed position; and
the second closing element has a second surface facing in a direction of the airflow to be controlled when the second closing element is in the closed position.

11. The air inlet of claim 10, wherein the first surface and the second surface respectively comprise a cylindrical surface.

12. The air inlet of claim 8, wherein:
the first closing element has a first surface facing in a direction remote from the airflow to be controlled when the first closing element is in the closed position; and
the second closing element has a second surface facing in a direction remote from the airflow to be controlled when the second closing element is in the closed position.

13. The air inlet of claim 12, wherein the first surface and the second surface respectively comprise a concave surface.

14. The air inlet of claim 13, wherein the first closing element and the second closing element respectively comprise a reinforcing rib provided on the concave surface and which extends along the pivot axis.

15. An air inlet configured to control airflow to a cooling device of an internal combustion engine for a motor vehicle, comprising:
a first closing element pivotably movable along a first pivot axis between an open position to permit airflow through the air inlet and a closed position which restricts airflows through the air inlet, the first closing element having a first surface facing in a direction facing the airflow to be controlled when the first closing element is in the closed position;
a first frame element operatively connected to the first closing element and about which the first closing element pivots;
a second closing elements pivotably movable along a second pivot axis in an opposing direction relative to the first closing element, the second closing element having a second surface facing in a direction of the airflow to be controlled when the second closing element is in the closed position; and
a second frame element operatively connected to the second closing element and about which the first closing element pivots.

16. The air inlet of claim 15, wherein the first pivot axis and the second pivot axis extend parallel to one another.

17. The air inlet of claim 15, wherein the first surface and the second surface respectively comprise a cylindrical surface.

18. The air inlet of claim 15, wherein:
the second closing element has a third surface facing in a direction remote from the airflow to be controlled when the second closing element is in the closed position; and
the second closing element has a fourth surface facing in a direction remote from the airflow to be controlled when the second closing element is in the closed position.

19. The air inlet of claim 18, wherein the third surface and the fourth surface respectively comprise a concave surface.

20. The air inlet of claim 19, wherein the first closing element and the second closing element respectively comprise a reinforcing rib provided on the concave surface and which extends along the pivot axis.
